(19) United States
(12) Patent Application Publication
(10) Pub. No.: US 2012/0158337 A1
(43) Pub. Date: Jun. 21, 2012

(54) Method and Integrated System for Improving Data and Service Quality with Respect to Measurement and Analysis of Reservoir Fluid Samples

(76) Inventors: Anil Singh, Edmonton (CA); Darcy Ryan, Edmonton (CA); Richard Dale Hulme, Katy, TX (US); Kurt Schmidt, Red Deer County (CA); Jefferey Woodel, Cypress, TX (US)

(21) Appl. No.: 12/971,950

(22) Filed: Dec. 17, 2010

(51) Int. Cl. G06F 19/00

(52) U.S. Cl. 702/84

(57) ABSTRACT

A technique facilitates substantially improved service quality and data quality with respect to measurement and analysis of reservoir fluid samples. The technique integrates a variety of components which simplify the actions involved in measurement and analysis of the reservoir fluid samples. As a result, the reservoir fluid analysis process is more reliable and repeatable during many or all phases of the procedure from job initiation to output of the data as a final report.

### BACKGROUND OF THE INVENTION

In many oilfield applications, reservoir fluid samples are collected and thermodynamic (e.g. Pressure, Volume, Temperature—PVT) and/or other physical properties studies are performed to obtain desired information on a subterranean reservoir. These studies are associated with generalized fluids analysis workflows which typically start when the sample is acquired at the wellsite and end when a final study report is issued and the study data archived. With respect to this workflow, a variety of internal procedures, work instructions, and service quality guidelines are provided regarding specific tasks in the workflow, e.g. sample management, fluid property measurements, data acquisition, data management, interpretation and analysis of data, quality checking, and report generation. For example, instructional manuals and quality guidelines may be provided for various tasks in the workflow. However, these procedures, work instructions and guidelines, even if standardized, are subject to interpretation which depends on the level of experience of operators and thus leads to a wide degree of variability in the aforementioned tasks in the workflow. Difficulties also arise in enforcing adherence to procedures and guidelines which can lead to poor data and service quality.

Additionally, existing fluid analysis equipment fails to provide sufficient real-time transmission capabilities. As a result, real-time expert support while at a remote site has been limited. Further limitations of existing fluid analysis workflows include a lack of traceability and a lack of a system that integrates the various aspects of the workflow, and a general inability to provide an automated, accurate, repeatable process of reservoir fluid analysis.

### BRIEF SUMMARY OF THE INVENTION

In general, the present invention provides a method and system which improves the overall service and data quality of thermodynamic and other physical property measurements and analysis of reservoir fluid samples. The method and system integrate a variety of components, equipment, software and support infrastructure, which seamlessly integrate, simplify, and make more efficient the actions involved in the reservoir fluid measurement and analysis workflow. As a result, the workflow for measurement and analysis of reservoir fluid samples is significantly improved, resulting in better service delivery (job and data management, sample and data traceability, for example) and data quality from job initiation to output of the data as a final report.

### BRIEF DESCRIPTION OF THE DRAWINGS

Certain embodiments of the invention will hereafter be described with reference to the accompanying drawings, wherein like reference numerals denote like elements, and:

FIGS. 1A and 1B are a schematic illustration of an example of a system for improving an overall reservoir fluid analysis process, according to an embodiment of the present invention;

FIG. 2 is a schematic illustration of an example of a high level infrastructure of the system for improving an overall reservoir fluid analysis process, according to an embodiment of the present invention;

FIGS. 3A and 3B are a schematic illustration of an example of a workflow for reservoir fluid analysis equipment;

FIG. 4 is a table illustrating examples of sample validation measurements and other measurements utilized in the system for improving an overall reservoir fluid analysis process, according to an embodiment of the present invention;

FIGS. 5A and 5B are a schematic illustration of a detailed example of data and infrastructure workflow conducted via the system and process, according to an embodiment of the present invention; and

FIG. 6 is a flow chart providing one example of an optimization workflow which may be performed by the system and process, according to an embodiment of the present invention.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a method and system which enhances the overall service quality and data quality with respect to measurement and analysis of reservoir fluid samples. A variety of components are integrated to simplify the actions involved in measurement and analysis of the reservoir fluid samples. As a result, the reservoir fluid analysis process is more reliable and repeatable during many or all phases of the procedure.

According to one embodiment, the system and methodology also effectively standardize procedures and processes regarding job management, sample and data management, and sample and data traceability. The technique also provides extensive, automated, rigorous quality control at all levels of the measurement and analysis workflow. In some embodiments, provisions may be made for measurements and analyses which fall outside the definition of standard processes and procedures so that overall quality assurance is maintained. The system and methodology may be employed at any location where fluid analysis is performed, such as wellsite locations. However, the technique is also amenable to implementation at other locations, such as mobile laboratories or permanent laboratories.

Examples of applications benefiting from the system and methodology include applications employing sample validation and phase behavior studies, e.g. pressure, volume, and temperature studies (PVT studies). The system and method may be applied to many types of reservoir fluids and reservoir fluid analyses. In the following description, reservoir fluids generally are fluids produced by a downhole formation and collected by a downhole sampling tool, by a wellhead sample tool, and/or by a sample produced from other surface equipment, e.g. separators.

As described in greater detail below, the system and methodology encompasses substantial improvements in the overall reservoir fluid analysis process, including improvements in the areas of sample validation and PVT applications. For example, the technique employs a unique utilization of fluid analysis equipment and fluids analysis software, e.g. equipment level and preliminary data analysis software and expert level-detailed data analysis software. Fluid analysis operations support infrastructure may also be incorporated into the technique.

The fluids analysis equipment comprises equipment with improved measurement accuracy, repeatability, and reproducibility. The equipment may also incorporate additional fluid property measurements through sensor technologies, such as liquid phase density, liquid phase viscosity, and saturation pressure sensing technologies. Depending on the specific application, the equipment is designed for reservoir fluids ranging from natural gas to heavy oils, while providing fast turnaround time from any remote location. The fluids analysis equipment may also be utilized to determine fluid chemistry, and sample validity (representative and/or uncontaminated) prior to continued analysis.

The fluids analysis software used at the equipment level for measurement and preliminary data analysis provides improved data acquisition which leads to improved data traceability. The software further facilitates standardization of analysis, experimental procedure, and data processing with flexibility for unusual cases. Additionally, the software enables online measurement data statistical analysis (e.g. error bars of standard deviation) and time series analysis during acquisition from sensors and other devices in real-time. In some applications, the fluids analysis software facilitates improved preliminary fluid analysis screening including sensor crosscheck and other quality control tools, e.g. automated X and Y functions, K plots, and preliminary Equation of State (EOS) modeling to confirm experimental validity, e.g. achieving equilibrium. Logs may be maintained for traceability and transparency with operator comments. The software also enables generation of standardized preliminary internal reports with flexibility for special cases.

The fluids analysis software employed at the expert level for detailed data analysis facilitates standardization of fluid characterization and EOS tuning with flexibility for unusual cases. The software also facilitates preliminary experimental planning by initial fluid property predictions and provides improved algorithms for interpretation and analysis, e.g. fluid characterization, EOS modeling, viscosity modeling, and other types of analysis. Additionally, the software is designed to enable error propagation analysis for reported values and to facilitate detailed quality control, including measurement raw data review, preliminary data processing review, and data processing. Fluid properties data processing, e.g. PVT data analysis and fluid property prediction via tuned EOS modeling, may also be employed. Logs may be maintained for traceability and transparency with operator comments. The software employed at the expert level also facilitates standardization of reporting and multi-tiered report generation with flexibility for special cases, e.g. final internal and client reporting. The software may also require specific inputs, such as a final signoff of a report before release with traceability.

The backbone of the operations support infrastructure comprises a business system software used throughout the lifecycle of a project for a variety of operations. Examples include sample and asset management, e.g. chain of custody, sample bottle tracking, and other management duties. The business system software or software backbone also facilitates project management, e.g. resource management, billing, reporting, approvals, and scope of work (SOW). As described in greater detail below, the operations support infrastructure improves data management, including storage, transfer, and retrieval of data or reports of all types. In one embodiment, the operations support infrastructure provides a central hub for data transfer and communications in real-time or otherwise. A support infrastructure may be established to provide connectivity in real-time or otherwise to facilitate transfer of data to and from remote locations relative to a central hub.

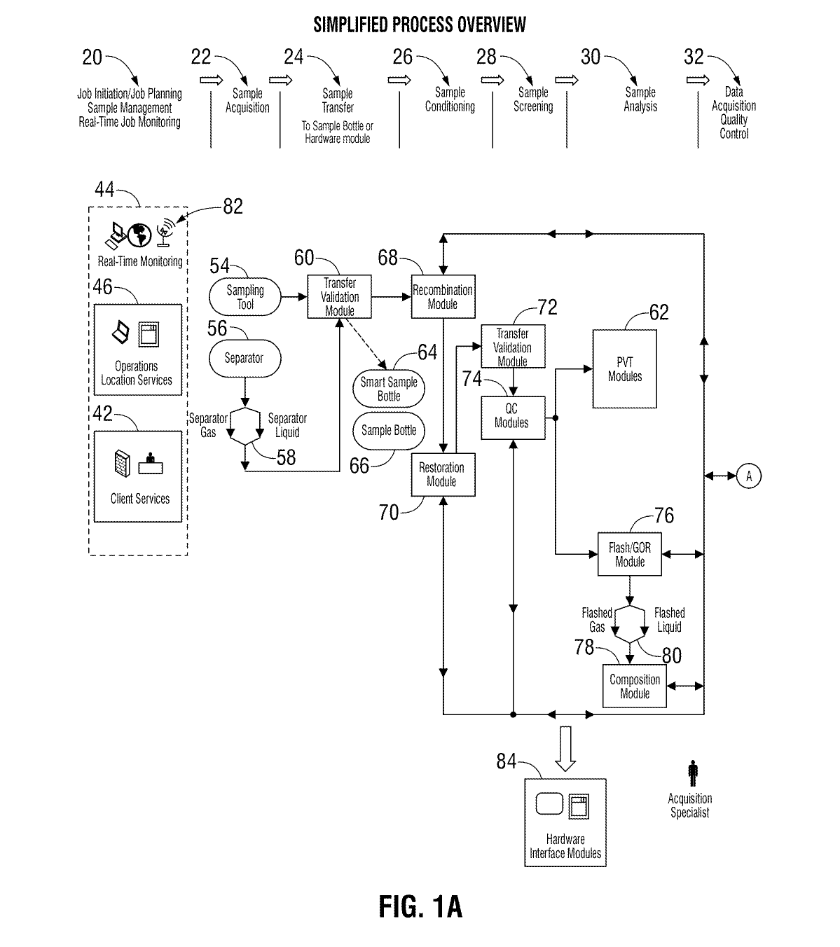

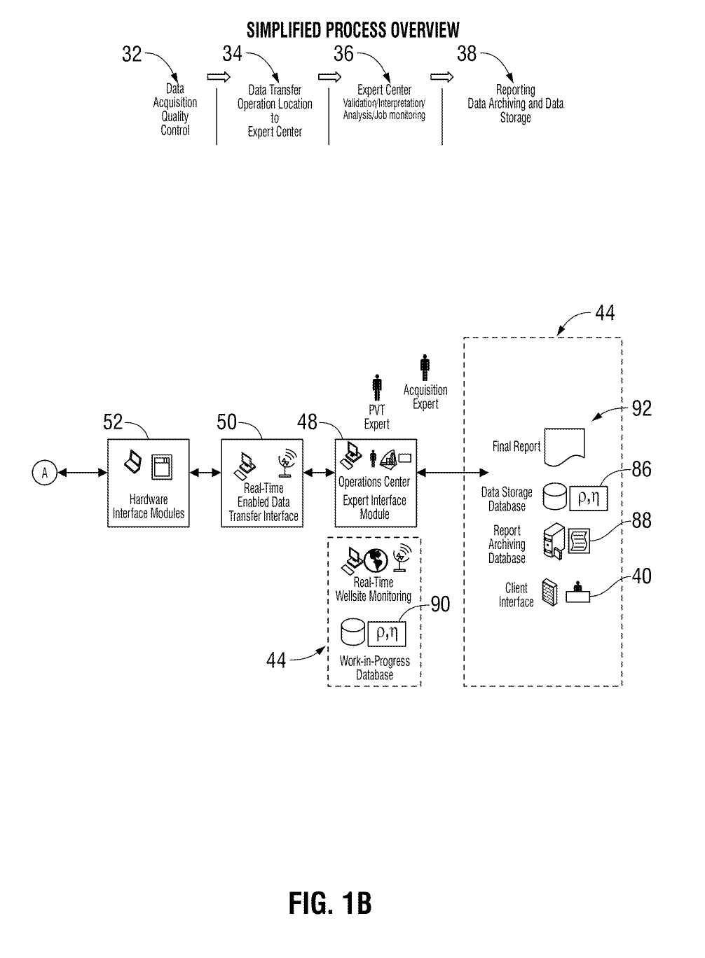

Referring generally to FIGS. 1A and 1B, an example of a system and methodology for improving service quality and data quality regarding measurement and analysis of reservoir fluid samples, e.g. hydrocarbon samples, is illustrated. In this example, the process encompasses the sampling lifecycle from the stage at which a sample is obtained from either a downhole tool or a surface device, e.g. separator, through stages of fluid measurement and analysis, data interpretation, reporting, and ultimately to sample storage and/or disposal. For example, the process comprises an initial job initiation stage 20 which may comprise planning for the sample management and real-time job monitoring. Following initiation, a sample acquisition stage 22 may be performed followed by a sample transfer 24. The sample is transferred to undergo sample conditioning 26 followed by sample screening 28 and sample analysis 30. The process may further comprise a data acquisition and quality control stage 32 and then data transfer 34 for data validation, interpretation, analysis, and job monitoring 36. Once the data is analyzed, a process completion stage 38 may be conducted in which the data is reported, archived, and/or stored.

The process may be carried out on a system comprising a variety of interrelated hardware and software components, as illustrated in FIGS. 1A and 1B. At the initial stage 20 of the sampling process or workflow, a job request is initiated by a secure client interface 40 from a client services software application 42 of an overall business system 44 which is a sample/data/job management tool. The request is received by a client's operations location application 46 where a job file is created, as discussed in greater detail below. The job file is created to set the scope of work and to initiate sample management, data management, and project/job management.

The job request may be downloaded by an acquisition specialist via an expert interface module 48 at an operations base location or remotely via a real-time enabled data transfer interface module 50. The real-time enabled interface module 50 allows data to be transmitted from a system interface module 52. In cases where there is limited or no connectivity, the system interface module 52 may be used to hold all data until connectivity is established where data can be synchronized. In some applications, further preliminary experimental planning may be performed via, for example, files appended to the job file and downloaded as part of the job file. Although the present system enables rapid execution of the entire sampling process, the process may be executed over varying lengths of time, such as hours, weeks, or months depending on client needs and circumstances.

The business system 44 ensures that client software applications 42, operations applications 46, and data transfer processes via module 50 are seamless with respect to system users, while providing two-way communications to allow changes to be made to the initial project plan and to reflect any variances. A local copy of the job file may be transferred onto system interface module 52 via real-time enabled data transfer interface module 50. A custody transfer or other method may be established to prevent changes to the same job file at two locations, thus preventing job file synchronization errors.

During the sample acquisition stage 22, one or more fluid reservoir samples are acquired from, for example, a downhole sampling tool 54 or from a surface component 56, such as a separator 58. However, sampling tool 54 may comprise a variety of types of sampling tools and surface component 56 may comprise a variety of surface components. A reservoir fluid sample from downhole or surface may be checked via a transfer validation module 60 at selected or all transfers during the sampling procedure. For example, the samples may be validated via transfer validation module 60 prior to charging the sample into PVT modules 62. If the sampling procedure is performed over hours, weeks, or months, repeated transfer validations may be needed. Furthermore, the physical location for each stage of the process may vary and thus chain of custody tracking may be employed.

Transfer validation module 60 is useful in measuring fluid properties such as pressure, temperature, density, viscosity, phase, and other fluid properties. The module 60 can also perform basic particulate, e.g. sand, and/or water contamination screening. A high-pressure filtration unit, as described in greater detail below, also can be placed either before or after the transfer validation module 60. Potentially, additional sensors may be added to transfer validation module 60 to measure additional fluid properties under flow.

During the sample transfer stage 24, a reservoir fluid sample is transferred into a transfer bottle 64 or 66. Transfer bottle 64 is an example of a smart sample bottle which can be fitted with sensors, such as pressure sensors, temperature sensors, density sensors, viscosity sensors, and other parameter sensors. Transfer bottle 66 may be used alternatively or in conjunction with sample bottle 64 and comprises a standard sample bottle.

During the sample conditioning stage 26, two operations may be conducted in the form of recombination and/or restoration. For example, gas samples and liquid samples taken from separator 58 may be recombined to a single phase homogeneous composition using a recombination module 68. Furthermore, any sample bottle 64, 66 can be restored to the downhole reservoir pressure and temperature or any other condition via a restoration module 70. Restoration module 70 has the capability of monitoring pressure and temperature and can be modified to include a plurality of other fluid properties sensors. The restoration module 70 may also work in cooperation with transfer validation module 60 or another transfer validation module 72 prior to being evaluated via a quality control module 74.

Recombined fluids, e.g. recombined liquid and gas components, may require restoration and a validation check of composition via a subsample sent to a flash module 76 and a composition module 78. The flash module 76 comprises a flash unit 80 employed for flashed gas and/or flashed liquid. Further validation of recombined samples may be performed by the PVT modules 62 or within recombination unit 68. If recombination unit 68 is employed, the unit may be modified to include a plurality of sensors for performing the validation checks.

As further illustrated in FIGS. 1A and 1B, the business system, e.g. sample/data/job management tool, 44 comprises a variety of additional features to facilitate the overall sampling process, as discussed in greater detail below. Examples of these additional features include real-time monitoring hardware 82, hardware interface modules 84, data storage database 86, report archiving database 88, work-in-progress database 90, and a report feature 92. The report feature 92 enables reporting of data on the fluid samples via, for example, a computer screen or other suitable display or medium once the fluid sample is acquired, transferred, conditioned, screened, analyzed, and otherwise evaluated for preparation of the final report.

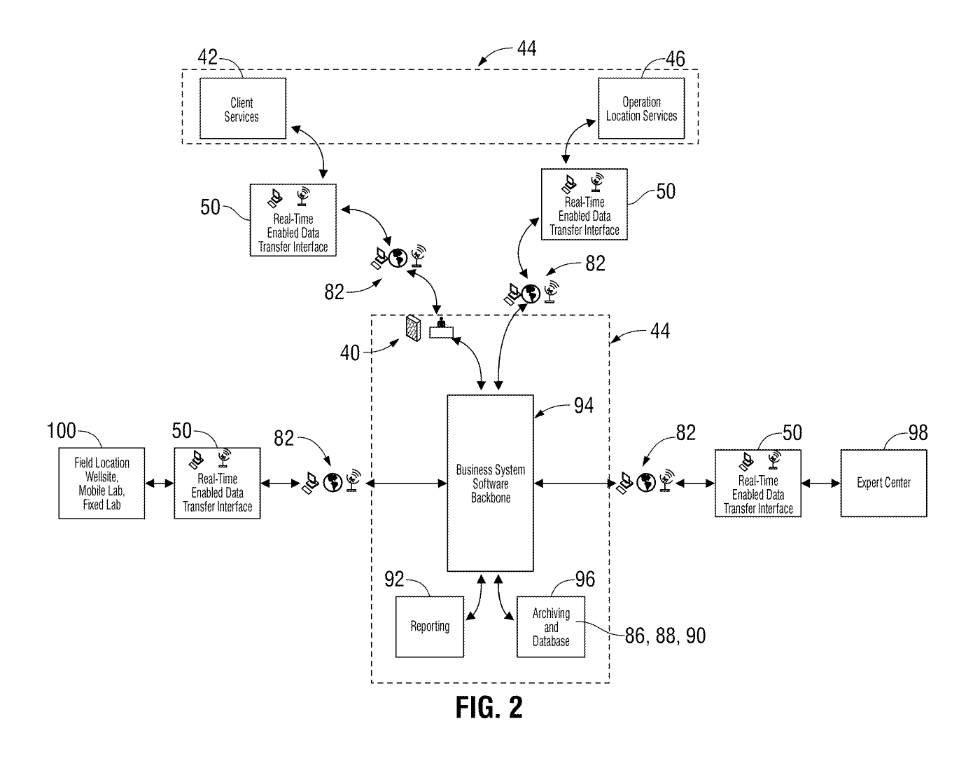

Before discussing subsequent stages of the sampling procedure, it is beneficial to review an example of a high level infrastructure for carrying out the procedure. Referring generally to FIG. 2, an embodiment of the infrastructure is illustrated as comprising the overall business system 44 which serves as a sample/data/job management tool. System 44 is based on a business system software backbone 94 which is communicatively coupled with business system features, such as a database module 96 which may comprise, for example, data storage database 86, report archiving database 88, and work-in-progress database 90. The software backbone 94 may also be coupled with other business system features, such as client services module 42 and operations location services module 46 via, for example, real-time monitoring hardware components 82 and real-time enabled data transfer interface modules 50. Desired instructions, parameters, and other data may be entered into system 44 via the secure client interface 40.

Depending on the specific reservoir fluid sampling application, the backbone 94 may also be coupled with other systems. For example, software backbone 94 may be coupled with an expert center 98 via real-time monitoring hardware components 82 and a real-time enabled data transfer interface module 50. Similarly, the software backbone 94 may be coupled with a field location/wellsite module 100 via real-time monitoring hardware components 82 and a real-time enabled interface module 50.

Referring again to FIG. 1A, sample screening stage 28 is used to screen or check on the restored and recombined samples. For example, the samples may be checked for cleanliness, water content, wax precipitation, asphaltene onset, and other factors. The screening may be performed by one or more quality control modules 74 which ensure the sample is acceptable for PVT or sample validation analysis and to detect any problems that may affect sensors. Additionally, restored samples may be sub-sampled to the quality control modules 74.

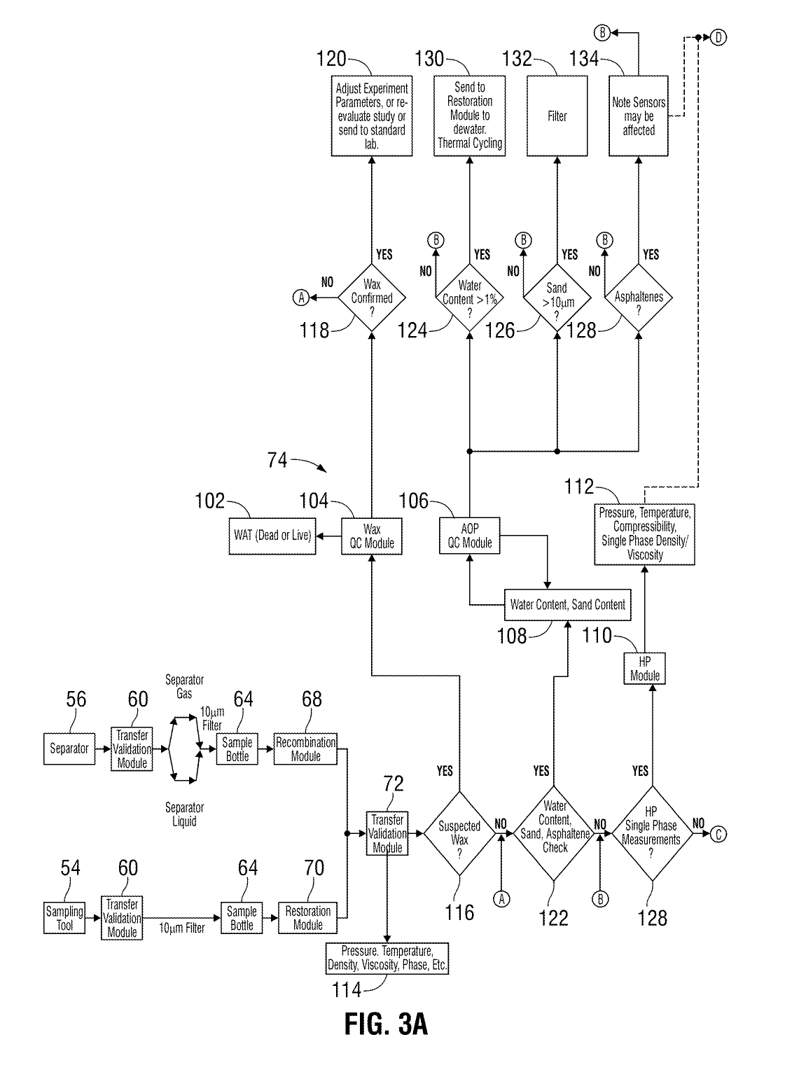

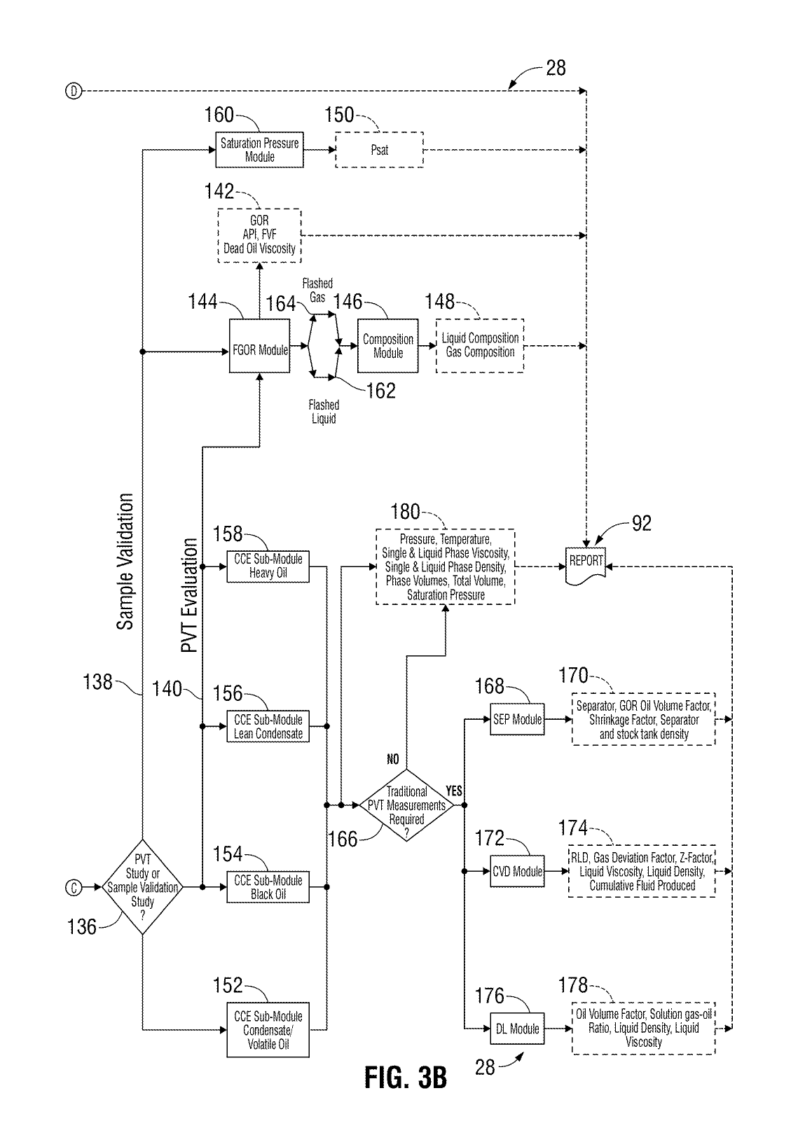

With additional reference to FIGS. 3A and 3B, a variety of sample handling and processing devices and systems are illustrated as examples of devices and systems which can be useful in the overall reservoir fluid analysis process. However, the unique and automated process for reservoir fluid analysis is described in greater detail below beginning at paragraph 0043. In FIGS. 3A and 3B, the workflow systems and hardware include quality control modules 74 and other components which are illustrated as a portion of the overall workflow. In this example, the quality control modules 74 may comprise a wax appearance temperature (WAT—dead or live) capability 102 via a wax detection module 104 and an asphaltene onset pressure (AOP) module 106 to provide asphaltene onset pressure. Water content and sand content sensor capability is provided by module 108. The quality control modules 74 may also comprise a high pressure (HP) module 110 having a pressure, temperature, compressibility, single phase density/viscosity sensor capability 112. The HP module 110 may be designed to provide additional functionality via software and/or sensor capability 112 by providing additional sensors, e.g. density and viscosity sensors, to provide high pressure, single phase measurements. Where sensor ratings are exceeded for mechanical or other reasons, these modules may be designed to provide basic compressibility measurements. In some of these applications, sample validation studies may not be required.

Confirmation of wax appearance via wax detection module 104 or the onset of asphaltene precipitation via module 106 may result in a variety of actions, such as adjusting parameters, discounting sensor data, or delivering the reservoir sample to a conventional PVT laboratory for further processing and/or analysis in a standard PVT cell. In many applications, a threshold water content of 1 percent or less is considered acceptable for PVT studies. However, if the water content exceeds this threshold, the sample may be dewatered via thermal cycling or another suitable technique. If the reservoir sample fluid has excess sand or other particulates greater than, for example, 10 μm, the sand may be filtered from the sample.

With respect to the overall workflow illustrated in FIGS. 3A and 3B, the reservoir fluid sample is initially obtained via downhole sampling tool 54 or from a surface component, such as a separator 56, delivered through transfer validation module 60, and routed into a sample bottle 64. The sample also may be delivered to one or both of the recombination module 68 or restoration module 70 before further validation via transfer validation module 72. The transfer validation module may comprise a variety of sensors 114, such as pressure, temperature, density, viscosity, phase, and other types of sensors.

If the presence of wax is suspected, as indicated by decision block 116, the sample is delivered to wax quality control module 104. The presence of wax is evaluated, as indicated by decision block 118, and if the presence of wax is confirmed, appropriate action is taken, e.g. adjustment of sampling parameters, as indicated by block 120. If no wax is confirmed, the sample is checked for excessive water content, sand, and asphaltene, as indicated by decision blocks 122 via modules 106 and 108. The presence of these constituents is evaluated, as indicated by decision blocks 124, 126, 128, and if the excessive presence of these constituents is confirmed, appropriate action is taken, e.g. dewatering via thermal cycling, filtering, or noting effects on the sensors, as indicated by blocks 130, 132, 134. If the presence of these constituents is not excessive, the sample is checked for undesirable high pressure single phase measurements, as indicated by decision block 128 via modules 110 and 112. Provided the high pressure single phase measurements are appropriate, the system initiates a PVT study or sample validation study, as indicated by decision block 136.

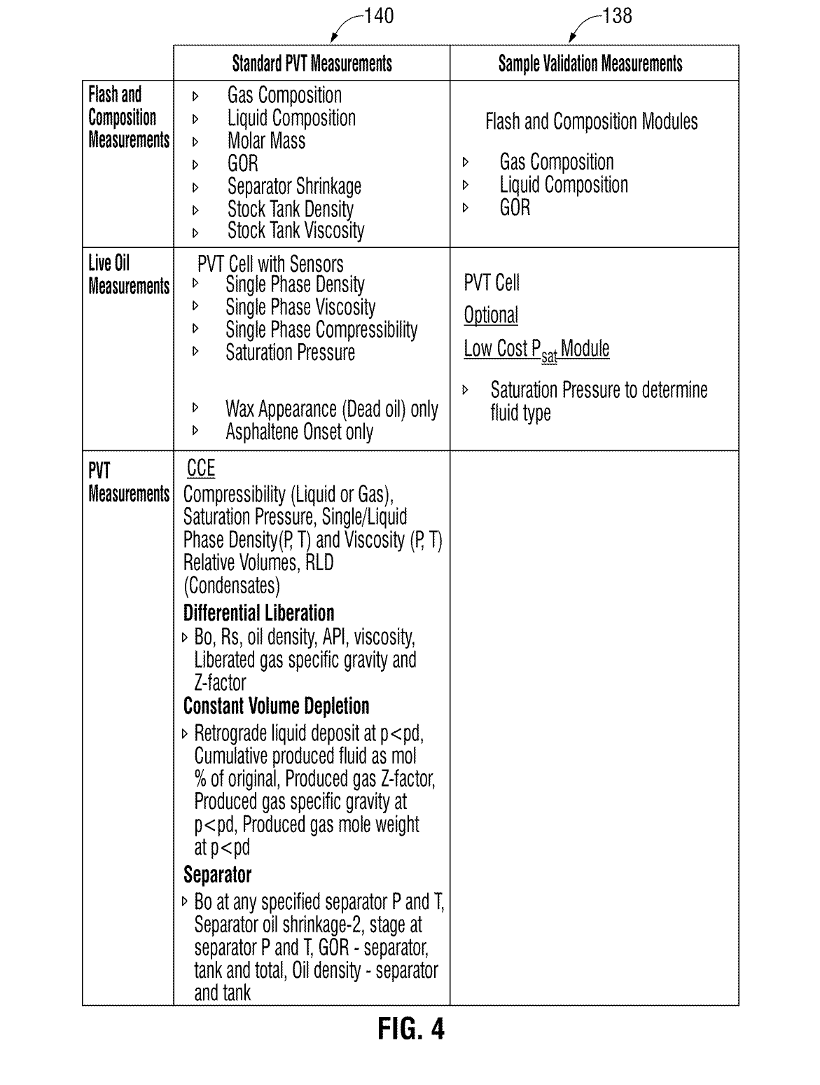

Referring again to FIG. 1A, the sample screening stage 28 may be followed by sample analysis stage 30. In this example, sample analysis may be divided into two broad categories involving sample validation 138 and PVT evaluation 140 (see FIGS. 3B and 4). With additional reference to FIG. 4, a summary is provided of various measurements which may be employed for sample validation 138 and PVT evaluation 140. The illustrated measurement sets include flash and composition measurements, live oil measurements, and PVT measurements. However, the illustrated measurement sets may be expanded to include other measurements beyond the standard PVT and sample validation measurement sets illustrated. The illustrated measurement sets are employed with reference to the workflow in FIGS. 3A and 3B to facilitate an understanding of the overall sampling procedure.

Sample validation 138 is performed to validate sample integrity or to confirm the fluid type of the reservoir fluid sample obtained from downhole samples, wellhead samples, and/or surface samples. Sample validation 138 includes testing for contamination, e.g. oil-based mud, and/or fluid type confirmation by measuring, for example, gas-oil ratio (GOR) using a flash GOR module (FGOR) sensor capability 142, an FGOR module 144, and/or a composition module 146, to determine fluid composition 148 and occasionally saturation pressure 150.

The sample analysis may be performed via PVT modules 28, such as constant composition expansion (CCE) sub-module 152 for analyzing condensate and a volatile oil; CCE sub-module 154 for analyzing black oil; CCE sub-module 156 for analyzing lean condensate; or CCE sub-module 158 for evaluating heavy oil. The PVT modules 28 may also comprise a separate saturation pressure module 160, as illustrated. In this example, a liquid sample 162 and a gas sample 164 may be provided to the composition module 146, and additional measurements, e.g. density and viscosity, may be added as additional modules or to an existing module, such as saturation pressure module 160.

PVT evaluation 140 may also be performed on PVT modules 28, FGOR module 144, and composition module 146 which are capable of making accurate and repeatable fluid property measurements. The fluid property measurements may be for constant composition expansion via, for example, sub-modules 152, 154, 156, and 158. However, if traditional PVT measurements are desired, as indicated by decision block 166, the fluid sample may be analyzed on additional PVT modules 28, such as a separator test (SEP) module 168 employed to provide data related to desired factors 170, e.g. separator factors, GOR oil volume factor, shrinkage factor, and separator and stock tank density. Another example of an additional PVT module 28 is constant volume depletion (CVD) module 172 used to provide data related to desired factors 174, e.g. retrograde liquid dropout (RLD), gas deviation factor, Z-factor, liquid viscosity, liquid density, and cumulative fluid produced. A further example of an additional PVT module 28 is differential liberation (DL) module 176 employed to provide data related to desired factors 178, e.g. oil volume factor, solution gas-oil ratio, liquid density, and liquid viscosity.

Sensor customizations may be based on the sensitivities and ranges required for the various fluid types, including condensates and volatile oils (PVT module 152), black oils (PVT module 154), lean gas condensates (PVT module 156), and heavy oils (PVT module 158). The module customization is also based on the configuration and geometry best suited to analyzing a reservoir fluid type. Reservoir fluids have a wide range of densities, viscosities, and GOR ratios. The modules or cells may be optimized to suit a given fluid type. In some applications one module and a set of sensors may be able to perform all the measurements on the fluid types, but this may reduce the accuracy of the fluid sampling procedure. In other applications, more accurate results can be obtained by designing the individual modules and corresponding sensors to suit a particular fluid type. During the sample analysis stage 30, it may be assumed that all relevant prior stages 20, 22, 24, 26, and 28 have been completed and the reservoir fluid sample is ready for PVT analysis. Furthermore, the results of the analyses via the various modules may be provided via final report feature 92 in a desired output form.

In the example illustrated, the FGOR flash module 144 is used to determine fluid properties and to obtain gas and/or liquid samples for compositional analysis in composition module 146. The CCE sub-modules 152, 154, 156, 158 may be selected based on the fluid type to enable the desired CCE measurements 180. These modules may be equipped with sensors to make the desired measurements 180, e.g. pressure, temperature, single and liquid phase viscosity, single and liquid phase density, phase volumes, total volume, and saturation pressure. The modules are designed to reduce operator variability, thus improving repeatability and reproducibility. Additionally, the sensors of these modules may be designed with a capability for making measurements which are traditionally taken from tests such as separator tests, constant volume depletion tests, and differential liberation tests. These traditional PVT tests may or may not be needed depending on the fluid and sampling requirements. The PVT modules 168, 172, 176 may be separate modules, or they may be combined with modules 152, 154, 156, 158. The combination only requires minor configuration changes, such as adding a sampling port.

As described in detail below, the present system and method provide a substantially improved overall reservoir fluid analysis process. The various sampling procedure stages described above and illustrated in FIGS. 3A and 3B characterize the physical flow of a reservoir fluid sample or samples through the various hardware modules for a sample validation and analysis in a PVT fluid sampling procedure. However, the overall reservoir fluid analysis process described herein also incorporates various software and infrastructure to improve the service quality and data quality for measurements and analysis of the reservoir fluid samples. The various modules and other hardware described above enable acquisition of the fluid property data. However, the software, additional hardware, and infrastructure described below is further integrated into the overall system (see FIGS. 1A, 1B, and 2) to deliver substantial reservoir fluid analysis improvements with respect to the overall procedure.

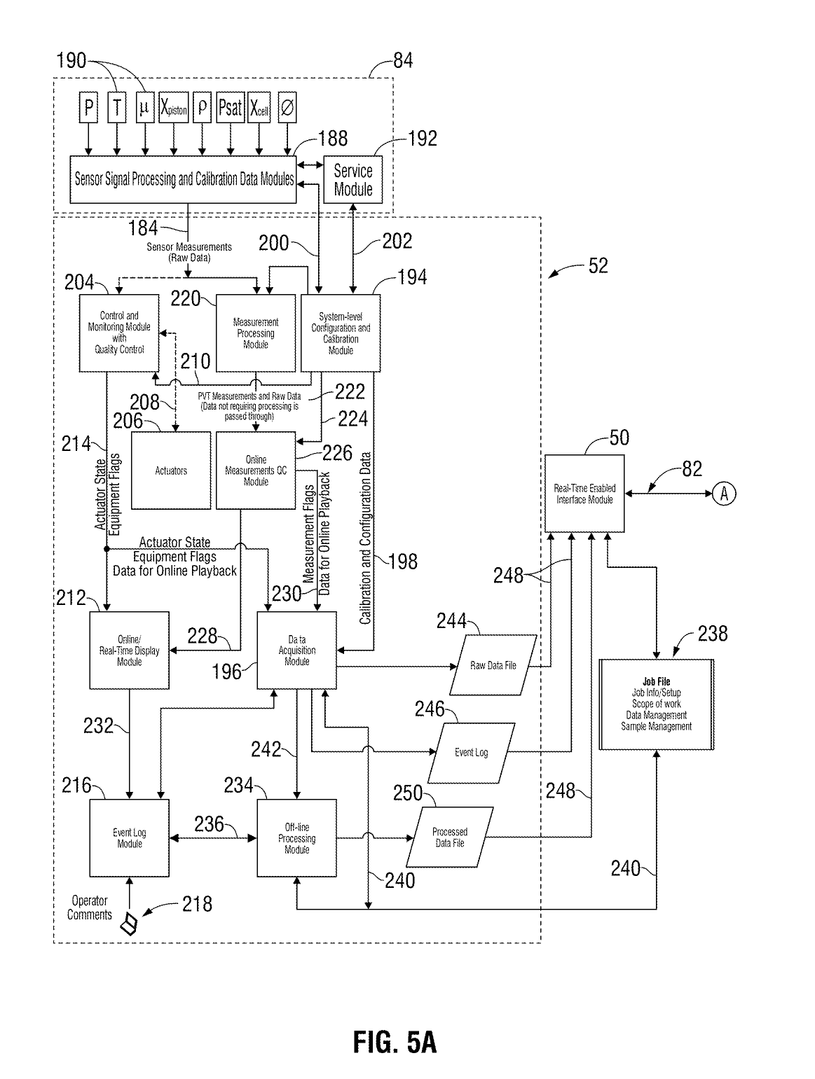

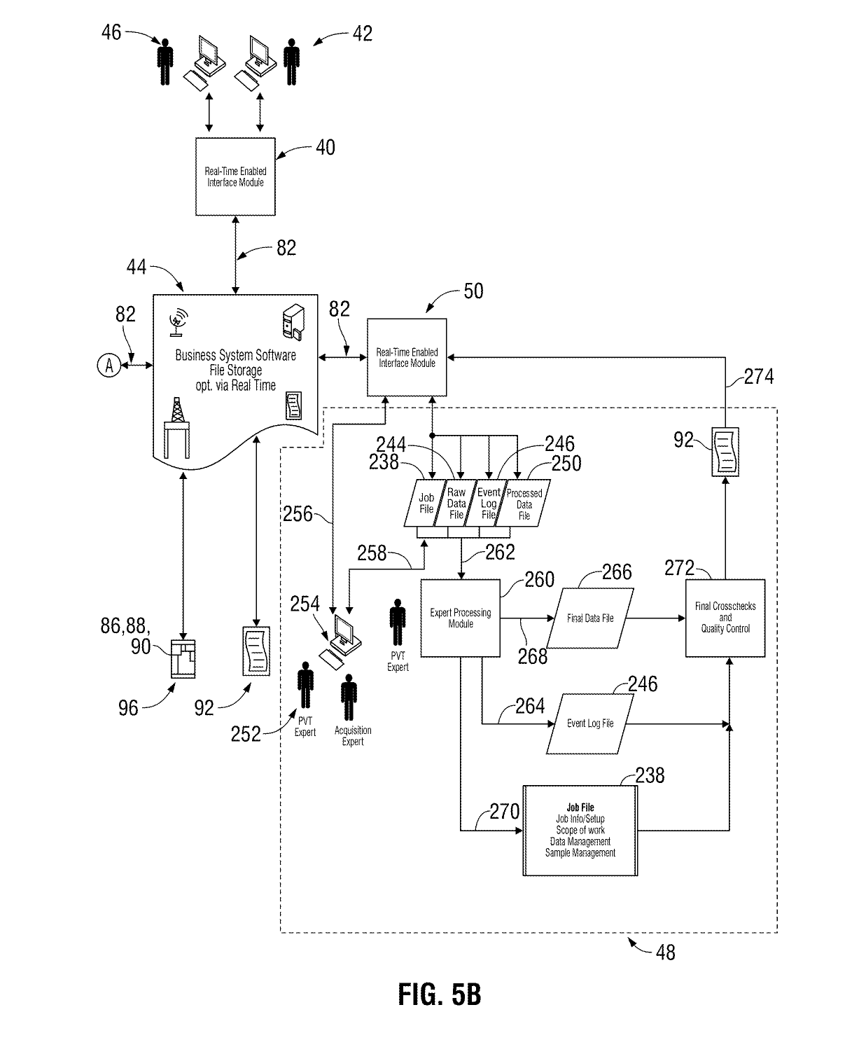

The fluid measurements, signals, and other data acquired from the various hardware modules illustrated in FIGS. 3A and 3B, are further processed and evaluated in the data acquisition and quality control stage 32. Referring generally to FIGS. 5A and 5B, an embodiment of the process workflow is illustrated with respect to further processing the fluid measurements, signals, and other data acquired from the modules illustrated in FIGS. 3A and 3B to carry out the overall reservoir fluid analysis. To simplify FIGS. 5A and 5B, the data and signals from these modules, e.g. modules 28, 60, 68, 72, and 74, have been idealized to hardware interface module 84. Hardware interface module 84 comprises a software module which interfaces with the sensors and other physical equipment illustrated in, for example, FIGS. 3A and 3B. For example, the sensors and other physical equipment may comprise data acquisition components, analog-to-digital conversion circuitry, and other components. The hardware interface module 84 may be employed to convert the data received to desired measurements, signals and/or other data.

According to one embodiment, the hardware interface module 84 serves four functions including data transmission via, for example, a data transmission link 184. The hardware interface module 84 also serves to interface with the individual hardware/equipment modules, e.g. modules 28, 60, 68, 72, and/or 74, and with the system interface module 52. Another function of hardware interface module 84 may comprise raw signal processing via a raw signal processing module 188. The processing module 188 processes raw signals 190 from the sensors, transducers, or other module components and converts these raw signals to more useful measurements or signals. Additionally, the hardware interface module 84 may be used to store calibration and configuration information specific to a module for the conversion of the raw signals and/or for calibration of validity self check information on start up. (For example, sensors may read properties of air or some other reference at start up.) The hardware interface module 84 may also comprise a service module 192 designed to facilitate manufacturing, maintenance, and engineering troubleshooting and support.

Data from the hardware interface module 84 is passed to system interface module 52. The module 52 interacts with all the individual hardware modules, e.g. modules 28, 60, 68, 72, and/or 74, and serves to connect “ad-hoc” purpose built modules into the integrated system. For sample validation and PVT analysis, this flexibility facilitates multiple configurations utilizing either single modules or sets of modules (e.g. modules 28, 60, 68, 72, and/or 74) to be run without the need for extensive software reconfigurations. In this embodiment, system interface module 52 is also able to connect with a real-time enabled interface 50 and business system 44.

The data stream 184 enters the system interface module 52 from one or more hardware interface modules 84. The datastream contains measurements or other data, e.g. pressure, temperature, and other measurements, and signal data used for equipment control and monitoring purposes, e.g. ambient temperature, ambient pressure, vibration levels, and other signal data. Data also is provided to a system-level configuration and calibration module 194. In the embodiment illustrated, module 194 has four functions which relate to calibration validity and verification; system configuration; reference information; and maintenance/troubleshooting. The system-level configuration and calibration module 194 reads the calibration information from the individual hardware interface module or modules 84 and stores system configurations which are used to set up tables for a data acquisition module 196. The information may be sent via a data link 198.

Module 194 also is used to check the validity of the calibration of the sensors and hardware components (see FIGS. 3A and 3B) and to store other necessary reference data used to process the PVT and sample validation measurements. Validity may be checked against a master reference file which contains calibration intervals, calibration validity thresholds, trend information (from previous start-ups), and other desired reference data. Checking the validity may be accomplished via data link 200. For maintenance and troubleshooting, the service module 192 can also access module 194. Data may be transmitted in either direction via data link 202 to allow for changes to be made, e.g. calibration updates and other changes.

A signal stream from hardware interface module 84 is also transmitted to a control and monitoring module 204. Module 204 may have three functions, including command-and-control; system monitoring; and level 1 quality control. System commands are based either on user input or preprogrammed sequences and criteria used to drive actuators 206, e.g. servo motors, pump drives, valves, and other actuators, to achieve optimum experimental control and stability. A standard feedback of signals via data link 208 and standard control techniques may be employed. Thresholds and status for monitoring measurements (e.g. ambient operating temperature, vibration level, and valve position) and standard deviation of measurements (e.g. pressure and temperature) are read in from the module 194 via a data link 210 used by control and monitoring module 204 for comparison. Exceeding these thresholds can affect measurements and hence the final product quality, and therefore operation outside the thresholds triggers a warning flag.

Other useful quality control tools, e.g. simple pressure versus volume or compressibility plots, using the raw data may also be plotted to gauge the progress and quality of the experiment during the acquisition process. The status information of the equipment and flags may be sent to an online real-time display module 212 via data link 214. The display module 212 visually summarizes the information for an operator and/or provides a visual and/or audible alarm. Accordingly, the display module 212 is able to help provide level 1 quality control. The operator can take corrective action to bring the experiment back into specifications and to flag data during alarm periods for masking or editing using, for example, an online electronic event log module 216 via data entry device 218, such as a computer. Any corrective action is captured by the system and stored in the data acquisition module 196. Data in addition to the equipment flags may also be stored in the data acquisition module 196 to enable playback either in real-time, or in a short time frame of the experiment, during data acquisition. This allows an operator and/or PVT expert and/or acquisition expert to review the information for verifying log entries, determining system status flags, reconstructing experiment events for troubleshooting, and/or coaching. The electronic event log module 216 can receive the operator entered comments via device 218 and can also receive system generated comments in response to certain events, e.g. exceeding the allowable maximum ambient temperature. In this example, the operator is not able to edit system generated comments which ensures full and secure traceability.

A measurement data stream from hardware interface module 84 is also transferred to a measurement processing module 220, if necessary. Measurements which do not require further conversion can simply pass through data link 222. Use of the measurement processing module 220 may be required where a measurement, such as volume, is calculated from a relative piston position and the geometry of the cell. The configuration data for the cell geometry is read from module 194 via a data link 224. Measurement processing module 220 has at least one function which is to convert sensor measurements to PVT or sample validation measurements.

Measurement data is then transferred via data link 222 to an online measurements quality control module 226. A function of online quality control module 226 is to perform online/real-time quality control checks on the measurement data, including, but not limited to, standard deviations and time series analysis. The acceptable limits in standard deviation and other acceptable limits may be held in the reference file and sent via data link 210 from system-level configuration and calibration module 194. This process also is part of the level 1 quality control. The measurement data, quality control data, and flags may be sent to the online real-time display module 212 via a data link 228 and to the data acquisition module 196 via a data link 230.

According to one embodiment, online real-time display module 212 has a series of standard and user configurable display windows which allow the data to be visualized while the acquisition system is online, i.e. during an experiment when the acquisition is active. The display may provide key sensor readings, such as pressure and temperature, standard deviation and other quality control plots, status visual alarms, event logs, trend plots, actuator position data, and other readings. Additionally, module 212 may be connected to an audible system for providing alarms.

Quality flags may be passed to the electronic event log module 216 via a data link 232. The event log module 216 is useful in storing important information at certain events, such as when a reading exceeds a predefined threshold on the equipment or when a change is made during off-line reprocessing using an off-line processing module 234 via a data link 236. The event log module 216 may also receive input from the off-line reprocessing module 234. Additionally, input can be manually entered via data entry device 218. In the example illustrated, events logged automatically by the software cannot be changed by an operator and this allows changes made during off-line reprocessing to be logged for traceability.

The data acquisition module 196 has hardware and software designed for rapid real-time data acquisition. The module 196 stores data from the system-level configuration and calibration module 194, data from the control and monitoring module 204, sensor and quality control measurements from quality control module 226, and data from the overall business system 44 via a job file 238 and a data link 240. Stored data can be used for real-time playback of the online acquisition and off-line mode. Data tables and acquisition channels are configured based on the information sent via data link 202. Data from the data acquisition module 196 is sent to the off-line processing module 234 via a data link 242. The data from module 196 is also used to generate various data structures, such as a raw data file 244, and an event log file 246 to be sent to the business system 44 via the real-time enabled interface module 50 through a data link 248 once a connection is established. When not connected, the file structures may reside in the data acquisition module 196. Alternatively, the file structures may reside in the real-time enabled interface module 50, in which case the interface module 50 serves as a temporary repository allowing multiple jobs to be run without a connection.

Raw data file 244 may contain a copy of the data as acquired from the data acquisition module 196, and the event log file 246 provides a copy of the event log. In this example, the raw data file 244 cannot be appended or overwritten. The event log file 246 cannot be overwritten, but it can be appended in this embodiment.

After the online acquisition is completed, preliminary analysis of the acquired data may be performed by the off-line processing module 234. The off-line processing module 234 may be used to perform quality control on the measurements of the experiment to provide a preliminary analysis of the reservoir sample fluids data. This level of quality control may be referred to as a level 2 quality control. A difference between level 1 and level 2 quality control is that the experiment must be complete to perform the level 2 quality control. By way of example, level 2 quality control may involve a more detailed analysis of parameters such as: fit of the pressure-volume plot; Hoffman plots; X and Y functions; mass balance; preliminary tuning of the EOS; and other such tools for gauging the quality of thermodynamic experiments. Changes made to the data are logged in the processing log contained in off-line processing module 234 which may be appended to the event log module 216 via data link 236. The processing log is able to log changes automatically and also to accept user input. Again, changes logged by the system may be unchangeable by an operator to allow for full traceability. Additionally, a processed data file 250 may also be created with the processed data.

Job file 238 may be updated by an operator to, for example, reflect any changes in the scope of work or to facilitate invoicing. Sample management and data management fields may also be updated. The job file 238 may be temporarily stored in real-time enabled interface 50 to facilitate updating upon connection of the core business system 44. Custodial control may also be implemented to prevent data from being updated in the business system 44 and from the field simultaneously. Accordingly, system changes may be made but only by one user at a time to enable validation and acceptance of the changes.

The data transfer stage 34 may follow the data acquisition and quality control stage 32, as illustrated in FIG. 1B. A simplified workflow in data transfer stage 34 utilizes a real-time infrastructure including real-time monitoring hardware 82 and software-based real-time enabled interface modules 50 which cooperate to provide real time transmission of data. The modules 50 serve as a main interface with business system 44 and may also serve as a temporary repository for storing the file structures 244, 246, 250, and job file 238. Upon connection, the file structures 238, 244, 246, and 250 may be transferred to the work-in-progress database 90, as illustrated in FIGS. 1B and 5B.

Real-time monitoring hardware 82 may include devices/systems to transmit data through a secure Internet connection or through a satellite link, and the hardware features both uploading and downloading capabilities. Real-time monitoring hardware 82 and interface module 50 enable real-time monitoring at client services 42 through the secure real-time enabled interface 40, and at operations location 46 through a data link connection or an expert center 252. Additionally, command-and-control may be conducted from the operations location 46 or expert center 252 through the real-time hardware 82. A satellite link enables operations in remote areas having no communication infrastructure, while still enabling data to be viewed in real-time at any global operational center. Effectively, persons at field locations, expert centers, or other locations granted access can be located in completely different regions while utilizing the sampling system. The business system 44 provides a core of the infrastructure linking the remote or other operational locations to, for example, expert centers 252. The link can be provided in real-time or otherwise for monitoring simultaneously via: the operations location 46; through secure connections at client services locations 42; and/or at operations/expert centers 252. This ability also facilitates coaching a field staff and/or providing real-time troubleshooting of the equipment or experiment.

After file structures 238, 244, 246, and 250 have been uploaded via hardware 82 and real-time enabled interface modules 50 to the business system 44, the file structures may be accessed at suitable locations, such as expert center 252 and/or operations location 46. The file structures may be stored in the work-in-progress database 90.

In the expert center stage 36, the expert interface module 48 may download file structures 238, 244, 246, and 250 which have been previously uploaded from the system interface module 52 via hardware 82 and interface modules 50. Real-time data may be made available while the experiment is conducted to facilitate monitoring and coaching at, for example, a workstation 254 of expert center 252 via a data link 256. Additionally, off-line playback of any experimental run may be reviewed at workstation 254 through a data link 258 using data from file structures 238, 244, 246, and 250. The off-line playback is useful for post-job analysis and training purposes when handling difficult or special fluids, or in cases where the operations location 46 and/or client desires access to time critical data to facilitate decisions while the acquisition crew remains on site. The off-line playback can also be used to re-validate the experimental run if certain portions of the data are in question post acquisition. Data masking and editing capability are also available in at least some embodiments. Any changes are updated at the event log 246 to maintain traceability.

The file structures 238, 244, 246, and 250 are loaded into an expert processing module 260 via a data link 262. Expert processing module 260 performs detailed quality control and error analysis, which may be referred to as level 3 quality control. The module 260 may also perform more detailed thermodynamic data processing for interpretation and analysis, including interpretation and analysis of thermodynamic data related to viscosity modeling, EOS tuning and predictions, and other thermodynamic data. Any changes made in the expert processing module 260 may be updated in the event log 246 via data link 264.

A copy of the raw data file 244 may be copied for reference in the event it becomes desirable to reprocess the raw data. Additionally, experts can review the results of various processing and reprocessed data as desired. A final data file 266 may be stored for upload via a data link 268 to the business system 44. Any changes to the job file 238 may be updated via a data link 270. The final data file 266 is designed with a draft copy of the final report template 92.

According to the illustrated embodiment, the final data file 266, updated event log 246, and job file 238 may be sent to a final crosscheck and quality control module 272. The crosscheck and quality control module 272 provides a review of all job data, sample data, experimental run information, processing parameters and method, and raw data, if required. Following the review, the final report template 92 is generated and sent to the business system 44 via data link 274 so that it may be released to the operations center 46 and the client services 42 through the business system reporting functions.

This final level of quality control is referred to as level 4 quality control and may be performed as part of the final reporting stage 38. The available data files 238, 244, 246, 250, 266 and the final report template 92 may then be moved from the work-in-progress database 90 to one or more permanent archive databases, e.g. databases 86 and 88. In addition, disposition instructions may be provided for the sample asset. The reservoir fluid sample or samples can be stored, returned to the client, or disposed, and this action can be entered in the final job file 238. Furthermore, the operations center 46 can adjust the final job once the disposition has been executed. Database 86 may also be designed to store all the data from the entire fluid data processing cycle, and the database may be configured to form a client specific fluid property database for archiving purposes. In this example, the database 88 is configured to store all final reports for archiving purposes and to allow full search and retrieve functionality. However, controls may be implemented to prevent overwriting final reports and/or processed data files via implementation of permission levels or other security measures. Also, data at the operations center 46 may include a comparison with data from the sample property database in some applications.

In operation, the system and methodology described herein provides a simplified process flow from an initial stage of scope of work generation through a final stage providing a final report submission for a client. The process facilitates an entire fluid analysis lifecycle by combining a business system backbone with operations acquisition specialists at any field location, fluid analysis experts at an expert center, acquisition equipment modules, and a variety of software modules to provide an integrated fluids analysis system.

The simplified process is carried out by using modular and/or portable equipment, e.g. modules 28, 74, 60, 64, 68, 70, 72, for making fluid property and/or fluid chemistry measurements at any location, e.g. wellsite, mobile lab, and/or permanent lab. Additionally, the business system 44 provides the backbone for the operations support infrastructure. This backbone functions as a sample/data/job management tool, a real-time infrastructure for job monitoring/control tool (see real-time monitoring hardware 82), a work-in-progress database 90, a final report template 92, a storage database 86, a data and report archiving database 88, and a secure client interface 40. The backbone also enables real-time data transmission and interfacing to other business systems via modules 50 and hardware 82. The real-time data transmission may be from remote locations to global operations support centers, which reduces turnaround time from sample acquisition to final report delivery and also enables real-time job monitoring, troubleshooting, coaching, and other functions. In the examples described herein, the backbone also may serve as a conduit connected to a maintenance asset management system to ensure equipment maintenance schedules are enforced, thus maintaining operational efficiency.

Enhanced modules 84, 52 and 48, e.g. software modules, also facilitate the processing of data. For example, the enhanced modules facilitate processing measurement data, processing fluids data, interpretation, analysis, and prediction with standardized workflows for more uniformity, and multi-level quality control and traceability.

Throughout the reservoir fluid analysis process, sample properties may be monitored by, for example, the smart sample bottle 64 and/or the transfer validation modules 60, 72. Sample consumption and sample asset tags may be stored and tracked by the business system 44 for enabling chain-of-custody tracking throughout the lifecycle.

Additionally, the hardware modules, e.g. modules 28, 54, 56, 60, 64, 68, 70, 72, 74, are integrated with software modules, e.g. software modules 44, 48, 50, 52, 78, 84, for job management and monitoring, data acquisition, quality control measurements, thermodynamic data analysis, preliminary/final report generation and submission, data transfer, data storage, and data management. The transmission of data from remote operations locations to expert centers, e.g. expert center 252, may be accomplished by a real-time connection or other type of connection using one or more interface modules 50 designed to interface with the business system 44.

Expert support centers may be shore-based and located geographically for 24-hour global coverage with respect to the performance of thermodynamic fluid data analysis, interpretation, and validation. Experts in measurement acquisition may also be available to facilitate troubleshooting and coaching of acquisition specialists deployed at a field location.

Furthermore, the various software modules may be designed as thermodynamic analysis packages able to perform PVT and sample validation studies. The software modules have capabilities ranging from, but not limited to, providing preliminary experimental planning; employing standardized (and provisions for non-standardized) processes and procedures built into a workflow structure to ensure repeatability and reproducibility; conducting raw measurement quality control, e.g. time series analysis or threshold analysis; ensuring experimental data quality control (e.g. thermodynamic quality checks); providing data processing traceability and quality control to detailed modeling; and facilitating interpretation and analysis of the thermodynamic properties of reservoir fluids.

As described above, the software modules enable standardization of workflow processes/methods for all aspects of the workflow, which ensures repeatability, reproducibility, and consistency. For exceptional cases, provisions may be made for non-standard events with guidelines to ensure overall quality assurance and consistency. In the reservoir fluid sampling procedure, unique quality assurance and quality control procedures and experimental measurements are integrated into the process workflow for sample validation and PVT measurement. The system also provides quality control of measurements and data processing through, for example, error bars and error propagation analysis for both PVT measurement and sample validation studies. The software modules also standardize methods for data processing while allowing flexibility for exceptions. As a result, the data quality control is less dependent on individual perception, and multi-level quality assurance and quality control are embedded in all levels of component and system software and in all aspects of the workflow from job planning to final report.

The overall system also improves the reservoir fluid analysis procedure by providing system logs, e.g. event log and processing log, and error flags which allow for full traceability of events (e.g. changes to parameters, exceeding thresholds, calibration information) on the equipment and/or related to the raw data/process data. This capability helps extend the traceability of the fluid sample by enabling chain-of-custody tracking of the sample and data.

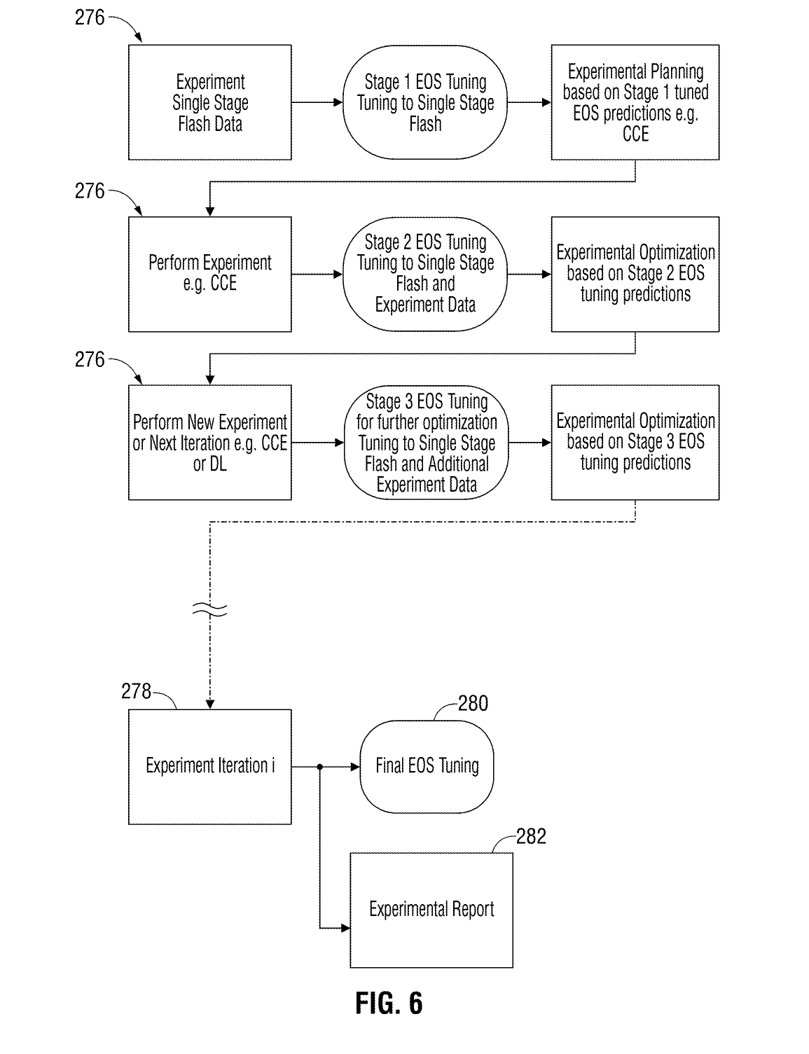

As illustrated in FIG. 6, the system and process also allows for timely optimization of experiments. Because data quality control is automatic and rapid, experimental runs 276 may be evaluated quickly to determine if the planned parameters, e.g. pressure steps or other parameters, are optimal. This facilitates efficiency and accuracy in applying experimental iterations, as indicated by block 278, to facilitate tuning of the experiment, as indicated by block 280, and generation of accurate reports, as indicated by block 282.

The automated quality control and integrated workflows of the present process significantly reduce the overall time of the fluid sample testing and reporting periods, compared to traditional methods. Based on real-time quality control and EOS modeling, subsequent sets of experimental measurements can be optimized or reduced based on prior data and the updated EOS model (see iterative process illustrated in FIG. 6). The real-time feature also allows an expert or experts to review the experiment while an operator is still at a remote wellsite, thus enabling optimization of the experiment. The optimization can be performed by tuning EOS and predicting the experimental parameters to improve data quality. In addition, the expert can provide coaching or other assistance, e.g. troubleshooting for a remote operator, to improve service and data quality.

In the reservoir fluid analysis process described herein, experimental parameters may be refined and the experiment/sampling procedure repeated without long delays and/or without leaving the wellsite. This capability helps avoid the complications and expense of returning to the site should major deficiencies be found in the data. Service quality and data quality are improved through rigorous quality control on: individual raw measurements; PVT/sample validation experimental data; data processing; and through real-time connection to experts and built-in software functionality. Service quality is also improved by the procedure through better data and asset management, such as the tracking of maintenance and calibration.

Additionally, the system and methodology described herein provide consistent and timely fluid analysis measurements with documented certainty, traceability, and global standardized procedures. Improved accessibility to fluid measurement and analysis is also provided, potentially throughout the globe, without requiring a permanent area lab location. The system and procedure connects clients, operations, field personnel, and experts by enabling global real-time collaboration and a real-time monitoring for optimization of studies and/or timely decision-making Procedural elements, such as planning, acquisition, and processing of sample validation and PVT data may be accomplished at different locations with available experts and clients on a continual basis. This connectivity and collaboration again serves to improve service quality and data quality. For example, rapid turnaround of finalized sample validation and PVT reports are enabled by the system and method.

It should be noted, however, the stages of the overall fluid analysis process may be adjusted for specific applications. Similarly, the size, type, and configuration of the various hardware and software modules may vary from one application and environment to another. Processing of data via the various software modules may be accomplished on computer-based systems, such as microprocessor-based computers, or on other processing systems utilizing individual or multiple processors. The types of data collected and the processing to which the data is subjected may also depend on the types of reservoir fluid samples collected and the desired information to be obtained from the analysis.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method for enhancing overall service quality and data quality with respect to measurement and analysis of reservoir fluid samples, comprising:
integrating all actions involved in a thermodynamic reservoir fluid sample measurement and analysis workflow from job initiation to output of a final report on characteristics of a fluid sample;
employing a plurality of hardware modules to obtain the fluid sample, transfer the fluid sample, obtain data for sample validation, and obtain data for a pressure, volume, temperature (PVT) evaluation;
utilizing a plurality of software modules in cooperation with the plurality of hardware modules to perform a plurality of analyses on the fluid sample and to establish a plurality of quality control levels;
controlling the plurality of hardware modules and the plurality of software modules via a system software backbone to standardize procedures and processes governing job management, sample and data management, sample and data traceability, and automated quality control; and
outputting results of the fluid sample process via a report medium.

2. The method as recited in claim 1, wherein integrating all actions comprises employing a hardware interface module to interface data from the plurality of hardware modules with the plurality of software modules.

3. The method as recited in claim 2, wherein employing a plurality of hardware modules comprises relaying data from the plurality of hardware modules to a system-level configuration and calibration module.

4. The method as recited in claim 2, wherein employing a plurality of hardware modules comprises relaying data from the plurality of hardware modules to a control and monitoring module.

5. The method as recited in claim 2, wherein employing a plurality of hardware modules comprises relaying data from the plurality of hardware modules to a measurement process module.

6. The method as recited in claim 2, wherein employing a plurality of hardware modules comprises relaying data from the plurality of hardware modules to a quality control module.

7. The method as recited in claim 2, further comprising outputting data to an online, real-time display module.

8. The method as recited in claim 2, further comprising establishing an online electronic log and an event log related to data received from the plurality of hardware modules and processed via the plurality of software modules.

9. The method as recited in claim 2, further comprising storing processed data in a data storage database and in a report archiving database.

10. The method as recited in claim 1, wherein employing a plurality of hardware modules comprises employing a plurality of quality control modules to measure parameters related to quality of the fluid sample.

11. The method as recited in claim 1, wherein employing a plurality of hardware modules comprises employing a plurality of PVT modules to enable sample validation and evaluation.

12. A method for conducting a reservoir fluid analysis process, comprising:
combining a software backbone with a plurality of hardware modules coupled to each other to obtain, transfer, validate, and evaluate a reservoir fluid sample;
employing the software backbone to process and thereby analyze data provided by the plurality of hardware modules;
establishing two-way communication between the software backbone and a client services module, an operations location module, an expert center, and a wellsite via real-time enabled interface modules; and
outputting reports based on the data processed.

13. The method as recited in claim 12, further comprising automatically storing data processed via the software backbone in a data storage database, a work-in-progress database, and a report archiving database.

14. The method as recited in claim 12, further comprising communicating between the plurality of hardware modules and the software backbone via a hardware interface module and a system interface module.

15. The method as recited in claim 14, wherein communicating comprises employing the hardware interface module to deliver sensor data from the plurality of hardware modules to a system level configuration and calibration software module.

16. The method as recited in claim 15, wherein communicating further comprises employing the hardware interface module to deliver sensor data from the plurality of hardware modules to a control and monitoring module.

17. The method as recited in claim 16, wherein communicating further comprises employing the hardware interface module to deliver sensor data from the plurality of hardware modules to a quality control module.

18. The method as recited in claim 17, wherein communicating further comprises employing the hardware interface module to deliver sensor data from the plurality of hardware modules to a data acquisition module.

19. The method as recited in claim 18, wherein communicating further comprises employing the hardware interface module to deliver sensor data from the plurality of hardware modules to an online real-time display module, an event log, and an off-line processing module to create processed data files.

20. A system to facilitate reservoir fluid analysis in an efficient, accurate, and repeatable manner, comprising:
a plurality of hardware modules which cooperate to obtain, transfer, validate, and evaluate a fluid sample from a subterranean reservoir;
a plurality of software modules which receive data from the plurality of hardware modules via a hardware interface module, the plurality of software modules processing the data to convert, calibrate, and store desired data related to the fluid sample; and
a software backbone operating in cooperation with the plurality of software modules and with a plurality of remote location modules, wherein two-way communication between the software backbone and the plurality of remote location modules is in real-time via real-time enabled interface modules and corresponding hardware to enable input and output of information via the software backbone.

21. The system as recited in claim 20, wherein the plurality of remote location modules comprises a client services module, an operations module, an expert module, and a wellsite module.

22. The system as recited in claim 20, wherein the plurality of hardware modules comprises validation modules and PVT modules.

23. The system as recited in claim 22, further comprising a plurality of software modules coupled in cooperation with the software backbone.

24. The system as recited in claim 23, wherein the software modules comprise a system-level configuration and calibration module, a control and monitoring module, a measurement processing module, a data acquisition module, a display module, and a storage database.
